(19) United States
(12) Patent Application Publication
(10) Pub. No.: US 2026/0027755 A1
(43) Pub. Date: Jan. 29, 2026

(54) METHOD OF PRODUCING SEPARATOR PLATES BY HOT COMPACTION

(71) Applicant: BLUE WORLD TECHNOLOGIES HOLDING APS, Aalborg Oest (DK)

(72) Inventors: Mads BANG, Støvring (DK); Jakob BORK, Støvring (DK); Denys GROMADSKYI, Svenstrup J (DK); Peter SCHIØNNING AASHOLM, Brønderslev (DK)

(73) Assignee: BLUE WORLD TECHNOLOGIES HOLDING APS, Aalborg Oest (DK)

(21) Appl. No.: 18/854,498

(22) PCT Filed: Apr. 4, 2023
(86) PCT No.: PCT/DK2023/050092

§ 371 Date: Oct. 7, 2024

(30) Foreign Application Priority Data
Apr. 5, 2022 (DK) PA202200321

(51) Int. Cl. B29C 43/36; B29C 43/52; B29L 31/34

(52) U.S. Cl. CPC B29C 43/361; B29C 43/52; B29C 2043/3634; B29C 2043/366; B29L 2031/3468

(57) ABSTRACT

A method for producing a separator plate, where a malleable compound of thermo-plastic polymer and electro-conductive filler is provided for hot-compacting into a separator plate. The compound is inserted into a press-form, which is heated to a first predetermined temperature in a heating station, and only then inserted into a press for hot compaction between press blocks, which simultaneously during the compaction take up thermal energy for cooling the press-form and the sheet, that is resulting in the separator plate.

### FIELD OF THE INVENTION

The present invention relates to a method of producing separator plates by hot-compaction, especially a continuous process.

### BACKGROUND OF THE INVENTION

Bipolar plates (BPPs), for example produced by combining two monopolar plates (MPP), are key components of fuel cells. They also play a role in electrically connections for providing the required voltage of the stack.

EP3041076A1 discloses a method of producing fuel-cell separator plates, wherein a multilayer sheet is preheated prior to compression molding in order to shorten the required molding time. The polymeric component of the sheet comprises a fluorocarbon polymer, in particular, FEP, PTFE, PFA, or a combination thereof. A preheating temperature range of 280 to 360° C. is specified. The melting points of the three mentioned polymer are 260° C., 327° C., and 315° C., so that the stated temperature range indicates molding when the polymers are molten, which, however, is not optimum. This is discussed in WO2021/028000.

WO2021/028000 by Blue World Technologies Holding discloses a continuous production process and facility including a mixing stage for mixing thermoplastic polymer material and a powder of electro-conductive filler, ECF, and a subsequent kneading stage for kneading the mix at a kneading temperature above a glass transition temperature for the thermoplastic polymer material but below a melting temperature for the thermoplastic polymer material in order to provide a malleable but not molten compound for causing fibrillization in the thermoplastic polymer material. It also discloses a pre-pressing stage after the kneading stage for pre-pressing the malleable compound into a sheet, and a hot-compaction stage for hot-compacting the sheet in a press-form to form a separator plate. The press-form has two oppositely arranged shaping press-plates with a sheet in between for being hot-compacted by the two press-plates. The press-plates are made from a material with a thermal conductivity of more than 100 W/(m·K) in order to minimize time for taking up heat from the sheet during press-moulding and also for cooling down the sheet quicky by transfer of thermal energy to the material of the press-plates for causing rigid solidification within a time in the press-form of less than two seconds. It is mentioned that a quick press-moulding procedure is beneficial in that the product can be pressed into its desired and final shape before the glass temperature is reached by one or more polymers in the compound. Also, quick cooling down of the sheet during press-moulding has an advantage of speeding up the production process, in general. In order to realize high-speed hot-compaction or compression molding, while at the same time cooling the formed sheet down by the press-plates within short time, materials for the press-form are provided with high thermal conductivity in order to take out heat and thereby cooling down the pressed MPPs as fast as possible. Examples of such materials that have high thermal conductivity are molybdenum, tungsten and some aluminum alloys like 2024-T351, 7075-T651 that have thermal conductivities of, respectively, 143, 197 121, and 130 W/(m·K). On the way to the press, the temperature of the malleable quasi-endless film as obtained during the kneading stage is maintained by the conveyors surface, which is heated, so that the film can be inserted into the press-form and pressed at a temperature in the range of 220° C. and 274° C. before the temperature drops due to thermal energy transfer to the press-form.

Although, this process and production facility as disclosed in WO2021/028000 does bring about some advantages over earlier prior art, it would be desirable to optimize the process further. In particular, it would be desirable to control the temperature of the polymer during hot-compaction better while still achieving a fast production.

### DESCRIPTION/SUMMARY OF THE INVENTION

It is therefore the objective of the invention to provide an improvement in the art. In particular, it is an objective to provide an improved method for production of separator plates, especially BPPs. In particular, it in an objective relatively to WO2021/028000 to control the heating process of the polymer film during the hot-compaction process better. Other objectives are found among a high speed production and simplicity in the production equipment and process as well as reduced size and costs for the production facility. One or more of these objectives are achieved with a method of production for separator plates, for example for fuel cells, as explained in the claims and in further details in the following.

In short, a method for producing a separator plate is provided, where a malleable compound of thermoplastic polymer and electro-conductive filler is inserted into a press-form, which is heated to a first predetermined temperature in a heating station, and only then inserted into a press for hot compaction between press blocks, which simultaneously during the compaction take up thermal energy for cooling the press-form and the sheet that is resulting in the separator plate.

For the production method, an endless band of a malleable compound is provided, the compound comprising a mix of thermoplastic polymer material and a powder of electro-conductive filler. Typically, the filler comprises carbon material as a dominant portion of the filler. The band is cut into a sheet and cropped to fit into a press-form. For example, the endless band is provided similar to the process and with the ingredients as disclosed and discussed in WO2021/028000, which is herewith incorporated by reference.

The press-form comprises a bottom press-plate and a support-frame, which in combination form a hollow that has lateral dimensions and a height H. In the case of a rectangular hollow, the lateral dimensions comprise length L and a width W. However, rectangular dimensions are not necessary, as the separator plates, in principle, could be round or have other flat shapes.

The press-form also comprises a cover press-plate that is covering the hollow. When the cut and cropped sheet is placed into the hollow, the cover press-plate is placed on top to cover the sheet.

For example, the cover press-plate is fitting tightly into the hollow. A tight fit, which still allows the cover press-plate to move smoothly into and inside the hollow within the support-frame, prevents the sheet material for the separator plate from being pressed out of the press-form during the hot-compression stage, where the press-form is placed in the press and the press-plates of the form are pressed together.

The press-form is used to give the separator plate rigidity and a flow field pattern, for example for coolant transport and/or for flow of hydrogen or oxygen. For this reason, the press-form comprises an embossing template in the bottom press-plate and/or cover press-plate, which during compression forms the flow field or flow fields for the separator plate.

For example, when the cover press-plate is positioned inside the hollow and resting on the sheet, a portion of the cover press-plate is extending a distance D above the support-frame. During hot-compaction of the sheet in the press-form, the sheet is pressed into a separator plate by pressing the cover press-plate deeper into the hollow.

For example, the distance by which the cover press-plate is pressed into the hollow during hot-compaction is measured and/or the pressure is measured. In such case, the depth by which the cover press-plate is moved into the hollow is determined by the pressure and the volume of the sheet material inside the hollow. These parameters can be adjusted in order to obtain the desired product.

In some embodiments, the press comprises a mechanism that is delimited to move the cover press-plate only a certain distance during the hot-compaction. An option is a knuckle press mechanism in which the knuckle press cannot push the cover press-plate further than a certain dead-point in the knuckle press.

In order to adjust the distance by which the cover press-plate is pushed into the hollow is potentially determined by an adjustment mechanism, for example adjustment sheets with different thicknesses that are selected by thickness in dependence on the distance by which the cover press-plate should be pressed into the hollow and which are placed between the press and the cover press-plate or between the press and the bottom press-plate.

For example, the cover press-plate is pressed a distance of less than the distance D into the hollow or at most the distance D.

An option is also that the support-frame of the press-form is used as a stop for the compression in the press. For example, during the pressing, the cover press-plate is pushed the distance D deeper into the hollow until the cover press-plate is flush with an upper edge of the support-frame in order for the support-frame to stop further compression of the sheet inside the press-form. Using the upper edge of the support-frame as a stop can be is useful, as the dimensions of the separator plate is determined in a simple way by hardware, which is very precise.

Especially, when the press-blocks have a size that extends beyond the support-frame of the press-form, push is only possible until the cover press-plate is flush with an upper level of the support-frame, as the support-frame stops the movement of the press-blocks towards each other. In this case, depending on the preset pressure and the volume of the sheet in the hollow, the cover press-plate is pushed no more than the distance D into the hollow. The distance D defines a maximum compression distance for the sheet during hot-compaction.

The press comprises two oppositely positioned metallic press-blocks, typically made of steel, and a driving mechanism, for example an electromechanical actuator system, for pressing the two blocks towards each other. Using an electro-mechanical actuator is advantageous over hydraulics in a much lower energy consumption and less heat generation.

The press has a press-region between the press-blocks in which the press-form is positioned for the hot-compaction. Furthermore, a conveyor is connected to the press-region for moving the press-form in and out of the press-region. With such conveyor, the insertion of the press-form into the press-region and the removal can advantageously be automated for a smooth and fast automated production sequence.

For example, the conveyor comprises a ball transfer table in which balls are rotationally embedded for easy sliding of the press-form on the rotating balls over the table and into the press. Inside the press-region, the balls are spring-loaded for being pressed into the table during pressing of the press-form between the press blocks. The platform is advantageously supported by the lower press block for stability reasons.

After placement of the sheet in the press-form, the press-form as well as the sheet inside the press-form are heated to a first predetermined temperature, which is a start temperature for the hot-compaction.

This temperature is above the glass transition temperature for the thermoplastic polymer material in order for the sheet to be formable. If the thermoplastic material in the mix comprises more than one polymer, the temperature above the glass transition temperature for the thermoplastic polymer material has to be understood as a temperature above the glass temperatures of all of the thermoplastic polymers in the mix, which is above the highest glass temperature of the thermoplastics in the mix.

Advantageously, as discussed in WO2021/028000, the temperature is below the melting temperature for the thermoplastic polymer material, in order to compact the compound in malleable but not molten state. If the thermoplastic material in the mix comprises more than one polymer, the temperature below the melting temperature for the thermoplastic polymer material has to be understood as a temperature below the melting temperatures of all of the thermoplastic polymers in the mix, which is below the lowest melting temperature of the thermoplastics in the mix.

Typically, the first predetermined temperature, at which the hot compression starts, is in the range of 250-350° C., for example in the range of 300-350° C.

The heating of the press-form is done outside the press-region in order not to occupy the press-region during the heating phase. This is part of an optimization process. Only when the press-form and the sheet therein have been heated to the desired temperature, the press-form is moved by the conveyor into the press-region in between the press-blocks. This external heating, where both the press-form and the sheet are heated, while the sheet is inside the press-form has the main advantage of a controlled first predetermined temperature prior to the start of the hot-compaction.

In the hot-compaction stage, a hot-compaction of the sheet is made in the press-form in order to transform the sheet into a separator plate with flow fields. For this, the press-blocks are pressed towards each other for pressing on the cover press-plate, for example pressing the cover press-plate deeper into the hollow, for shaping the flow pattern in the separator plate with the embossing template. High pressure is used, advantageously in the range of 100 to 300 MPa. Due to the high pressure, the press time can be made advantageously short, while still being efficient enough for forming the flow pattern.

In this relation, it should be kept in mind that the temperature during the pressing is quickly transferred by thermal conduction from the press-plate material, which advantageously is molybdenum with its high thermal conductivity, to the press-blocks of the press, as the press-blocks are made of metal, typically steel. By efficient heat conduction from the sheet, through the press-plates, and into the press-blocks, the temperature of the sheet and the press-form is lowered from the first predetermined temperature to a second predetermined temperature under the glass transition temperature of the polymer in the sheet and causing rigid solidification of the formed separator plate.

For efficient cooling, the press-blocks have a much larger thickness than the press-plates, for example a press-block thickness of more than ten times the thickness of the press-plates in order for the press-blocks to have volume enough to take up the heat from the press-plates during the pressing action, so that the pressing at the same time also provides the necessary cooling process for the press-form for the separator plate to cool down to a temperature where it has solidified. This procedure is advantage in that it speeds up the process.

For example, the timeframe for the cooling process is typically less than 5 seconds, optionally within a timeframe of 1-2 seconds.

Finally, the rigidly solidified separator plate is removed from the press-form.

As the press-form is not heated inside the press-region, it is convenient for a rapid production line to provide one or more further press-forms. During the hot-compaction stage, one or more of the further press-forms are filled with a corresponding further cropped sheet, and after removal of the press-form from the press-region, another of the further press-forms is inserted into the press-region for hot-compaction of the further sheet into a further separator plate.

Taking offset in WO2021/028000, further study of the various materials proposed in WO2021/028000 for press-plates has led to selection of molybdenum as material for the press-plates. Although, molybdenum does not have the highest thermal conductivity among the four materials suggested in WO2021/028000, it has a very high hardness, which is even comparable to steel. The specific selection of molybdenum has been found particularly useful because the press-form is subject to very high pressure.

When comparing with WO2021/028000, some of the improvements should be particularly emphasized as per the following, although, the aspects have been described at least partially above.

A first and main improvement has been found in heating the press-form to the desired hot-compaction temperature in a specifically designed heating station, while the sheet is already inside the press-form. This heating station is outside a press-region of the press, and only when the press-form has been heated sufficiently to the first predetermined temperature, it is inserted into the press-region of the press for compaction of the sheet. Such procedure is not disclosed in WO2021/028000, where it reads instead that the sheet is held at high temperature by the rollers and then inserted into the press-form for cooling and hot-compaction, which implies a risk that the hot-compaction cannot be performed quick enough relatively to the cooling action on the sheet by the press-form. Also, WO2021/028000 explains the cooling of the sheet by transfer of thermal energy to the press-plates. However, this type of cooling is difficult to control, as the temperature change of the sheet starts immediately upon contact with the press-plates, unless the press-plates are heated to the same temperature as the sheet. Also, the press-plates have to be made thick in order to have the necessary thermal capacity to take up sufficient thermal energy from the sheet to reach the temperature under the glass transition temperature. Accordingly, in contrast to WO2021/028000, by heating the press-form including the sheet and not only the sheet itself outside the press, a thorough control of the first predetermined temperature at the start of the hot-compaction process is safeguarded.

A second improvement relatively to WO2021/028000 has been found in that several press-forms can be in a waiting position for hot-compaction at the predetermined first temperature with a corresponding sheet inside, so that the hot-compaction process can be done in a rapid sequence with one press-form inserted into the press-region after the other, optimising the production process with respect to speed. This implies that the press itself does not need a heater for the press-form. It also implies optimised utilization of the press with respect to the overall production capacity.

A third improvement relatively to WO2021/028000 has been found in providing the press-blocks in metal, typical steel, and at much larger thickness than the press-plates so that the heat taken up from the sheet by the press-plates is transferred quickly from the press-plates by take up of thermal energy by the press-blocks that press on the press-plates. This accelerated the cooling process.

A further improvement relatively to WO2021/028000 has been found in the press-blocks being maintained at a second predetermined temperature by cooling, where the second predetermined temperature is much lower than the first temperature of the press-form during the start of the hot-compaction. The second predetermined temperature is in the range of 50-100° C., for example on the range of 60-80° C. By maintaining the press-blocks at such predetermined cooling temperature, the cooling process from the first to the second predetermined temperature is precisely controlled with high cooling speed. Furthermore, during the time of the press-form being removed from the press and until the next press-form is inserted into the press, the thermal energy taken up by the press-blocks can be removed efficiently by the cooling so that the press-blocks are quickly ready for taking up energy from the next press-form that is inserted into the press-region for hot-compaction of the next separator plate. This principle has also proven to accelerate the process as compared to some prior art where a press-form is heated inside a press. For example, the press-blocks are efficiently cooled by coolant flowing through cooling channels inside the press-blocks.

In a practical embodiment, the press comprises a frame having an upper frame-part and a lower frame-part. The lower part of the frame is fastened to the lower press-block and the upper part of the frame is above the upper block with an actuator pressing the upper block downwards and away from the upper part of the frame during the hot-compaction. The force exerted on the press-form will result in the sheet being compacted in the press-form.

For example the force exerted on the cover plate is involving total forces in excess of 1000 tons between the press-blocks. As an example, for a cover press-plate of size 10 cm×50 cm=500 cm², a press of 1000 tons on the press-plates results in a pressure of 2 tons/cm²=2000 bar=200 MPa.

For the actuator, electro-mechanical solutions are preferred over hydraulic systems, as the energy consumption for the pressing is much lower than for hydraulic systems at such high pressures. Optionally, the press comprises an electro-mechanical knuckle mechanism where a spindle is driven by an electrical actuator, the spindle moving a knuckle, advantageously double-knuckle, which is mechanically acting between the upper part of the frame and the upper block so as to move the upper press-block relatively to the upper part of the frame towards the lower press-block.

For the specific embodiments, in which the thermoplastic polymer material comprises at least two thermoplastic polymers, the first predetermined temperature for the start of the hot-compaction is adjusted to above the highest of the glass transition temperatures for the at least two thermoplastic polymers but below the lowest melting temperature for the at least two thermoplastic polymers. Thus, all polymers are kept at a kneading temperature above their various glass transition temperatures in order to be malleable and below their various melting temperatures. The temperature of the formed separator plate is then reduced to the second predetermined temperature under the lowest of the glass transition temperatures for the at least two thermoplastic polymers while under pressure in the press-form in order to cause rigid solidification of all of the at least two thermoplastic polymers prior to removing the rigidly solidified separator plate from the press-form.

For example, the thermoplastic polymer material comprises or consists of thermoplastic polymer of a first group and thermoplastic polymer of a second group. By selecting polymers from two different groups, physical parameters related to structural stability, toughness, and chemical inertness, among others, can be adjusted to yield an optimum thermoplastic polymer material for the separator plate. For example, the thermoplastic polymer of the first group is primarily used for creating structural stability, and the thermoplastic polymer of the second group is primarily used for toughness to prevent breaking. In order to create toughness of the compound material, the selected polymer from the second group should be fibrillizable by kneading. The ratio between the polymer or polymers of the first and the second group are adjusted for optimization. In some embodiments, the compound comprises a higher amount of polymer of the first group than polymer of the second group.

For the case that the final separator plate is should be used for HT-PEM fuel cells, both groups should have melting points above 200° C. Furthermore, it is advantageous, if the polymer of the first group has a flexural strength higher than 100 MPa in order to provide good structural stability of the separator plate.

A highly useful candidate as thermoplastic polymer is polyphenylene sulfide (PPS). However, polyether ether ketones (PEEK), polyetherimide (PEI), polysulfones (PSU), are useful alternatives. These polymers belong to a first group of polymers, which have high thermal stability, chemical resistivity, and high flexural strength. As an example, PPS is an advantageous binder for separator plates, especially MPPs and BPPs, because it is not dissolved in any solvent at temperatures below 200° C., and it has high melting point in the range of 271-292° C., which is depending of the degree of crystallinity and molecular weight. Its melting point is significantly higher than the operation temperatures of HT-PEM fuel cells, which is in the range of 120-200° C.

Candidates of the second group of polymers include tetrafluoroethylene (ETFE), fluorinated ethylene propylene (FEP), polychlorotrifluoroethylene (PCTFE), polytetrafluoroethylene (PTFE). The polymers of the second group have relatively high tensile elongation, and can be fibrillated, especially by kneading.

Advantageous characteristics for this second group are among the following:
a melting temperature higher than 200° C.;
a continuous service temperature at least 120° C.;
a tensile elongation higher than 100%, for example is in the range of 100% to 300% or in the range 200% to 300%;
tendency for fibrillization by kneading.

Furthermore, the glass transition temperature of the second group should be lower than the melting temperature of the polymer of the first group when used in combination.

Using both groups of polymers in a mixture yields an advantage because their individual useful properties can be combined. As an example, a mix of PPS and PTFE can be used as a combined binder for the electro-conductive filler. Especially, PTFE is highly advantageous over other thermoplastic binders when in combination with PPS due to through its high decomposition temperature (410° C.), inertness and other unique properties, including low coefficient of friction, high strength, toughness and self-lubrication.

For the reasons of low electrical resistance, the concentration of ECF should be relatively high, for example more than 60% by weight, for example more than 70% by weight.

After the hot-compaction, typically, no further structuring by machining of the separator plate is necessary. For example, the method comprises hot-compaction the sheet into a bipolar plate with a flow channel pattern on each side of the bipolar plate. Alternatively, MPPs are produced and two of such MPPs combined back-to-back into a single BPP, typically by gluing.

Optionally, the separator plates are arranged as an array with fuel cell membranes between the separator plates, the membranes separating the hydrogen fuel from the oxygen gas.

The production method is not only suitable for BPPs, for example provided by combining two MPPs. It applies equally well to other separator plates, such as cathode plates, anode plates and cooling plates.

The invention is especially useful for fuel cells, especially proton exchange membrane (PEM) fuel cells, for example high-temperature proton exchange membrane (HT-PEM) fuel cells. High-temperature PEM fuel cells have a great advantage as compared to low-temperature PEM fuel cells, namely the possible operation with impure hydrogen, e.g. reformate gas, due to the high tolerance to carbon monoxide therein. But relatively high working temperatures (120-200° C.) in combination with concentrated acid media inside the fuel cell lead to the necessity of using inert, thermally stable polymers for binding the powdered or pelletized electro-conductive fillers (ECFs).

However, although, the invention is especially useful for fuel cells, particularly for high temperature proton exchange membrane (HT-PEM) fuel cells, it could be also used for other electrochemical energy storage and conversion devices, for example, batteries, double-layer capacitors or electrolyzers.

It is pointed out that all stated percentages for concentrations and amounts are percentages by weight (wt %).

### SHORT DESCRIPTION OF THE DRAWINGS

The invention will be explained in more detail with reference to the drawing, wherein

FIG. 1 illustrates an example of a fuel cell stack;

FIG. 2 illustrates a production process for a separator plate;

FIG. 3A is a sketch of an exemplified press-form in front view and FIG. 3B in side view;

FIG. 4 illustrates an example of a conveyor.

### DETAILED DESCRIPTION/PREFERRED EMBODIMENT

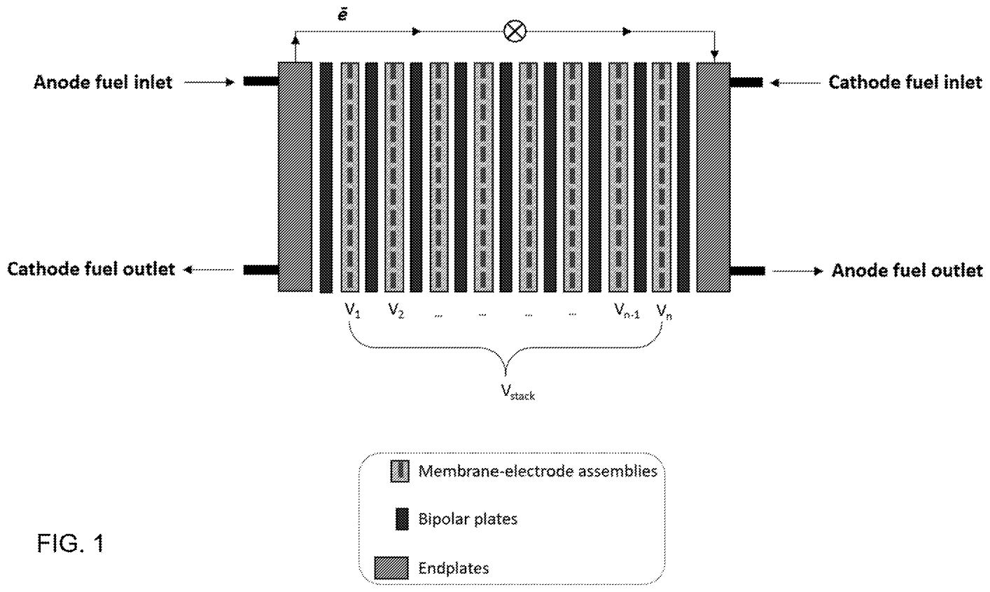

FIG. 1 illustrates an example of a fuel cell stack. Separator plates, exemplified in FIG. 1 as bipolar plates (BPPs), are one of the key components of fuel cells, as they play role of separating membrane-electrode assemblies in fuel cell stack, while at the same time electrically connecting the fuel cells in the stack serially so that the voltage of the stack is a sum of the voltages of the cells. In fuel cell, fuel that contains hydrogen is supplied through an anode inlet, and oxygen is supplied through a cathode inlet. The hydrogen and oxygen combine to water, which is dispensed through a cathode fuel outlet, whereas remaining hydrogen is removed through an anode fuel outlet, for example for being used in a burner that is used in combination with a reformer in order to provide energy for the reforming process. Separator plates, especially BPP, typically have flow fields on both sides as flow guides for the gases. Separator plates are also known to have flow fields for coolant. For example, two monopolar plates, MPP, may be combined back-to-back to form a BPP with a coolant flow field in a volume in between the two MPP.

Flow guides are typically provided in the separator plate during production by embossing channel patterns during hot-compaction.

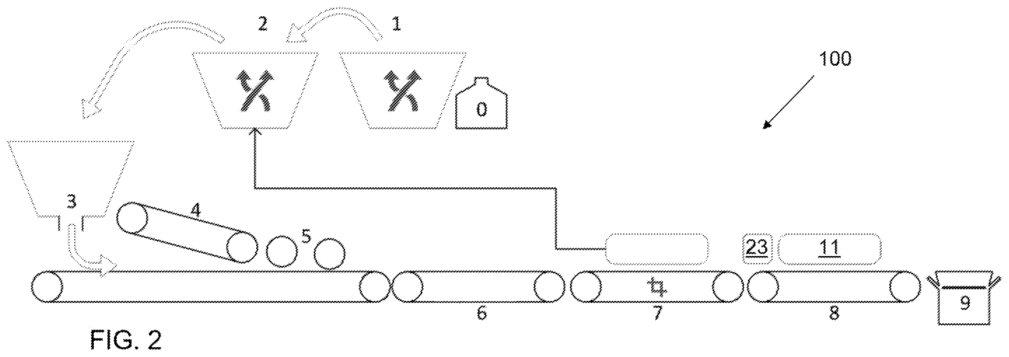

FIG. 2 exemplifies a continuous process for production of separator plates, for example MPPs or BPPs.

In a mixing stage 1, raw materials are provided from a dispenser 0 and mixed in a mixer. Advantageously, multiple polymers are combined with an electroconductive filler, ECF. For example, a first type of polymer is selected among a first group of polymers that have a high degree of thermal stability, chemical resistivity and good flexural strength. Examples include polyphenylene sulfide (PPS), polyether ether ketones (PEEK), polyetherimide (PEI), polysulfones (PSU). Another polymer is selected among a second group of polymers that have relatively high tensile elongation, and advantageously also can be fibrillated, especially by kneading. Examples include fluorinated ethylene propylene (FEP), polychlorotrifluoroethylene (PCTFE), polytetrafluoroethylene (PTFE). Examples of ECF are amorphous carbon, carbon black, carbon fibers, carbon nanotubes, graphene and/or graphite. For example, the ECF comprises a dominant concentration of graphite and/or carbon black.

Optionally, surfactants are added as wetting agents and may assist polymer nanoparticles to penetrate deeper into pores and cracks of the ECF. In order to reduce the content of water and/or other liquids in the mix, the temperature is increased to cause evaporation.

A kneading stage 2 is used after the mixing stage 1 for high-temperature kneading in a kneading container. The aim of this kneading operation is the fibrillization of the polymer. For this, the temperature is held above the glass transition temperatures of the fibrillizing polymer in order to achieve fibrillization. The increase of temperature has a positive effect until reaching the melting point of one of the polymers because polymers at melted condition flow too rapidly. It has turned out melting one or more of the polymers is less useful as it leads to increased areal specific resistance of the produced BPPs. The kneading is done for a time sufficiently long to cause substantial fibrillization in the polymer. The time depends on the kneading process. Typical kneading times are in the range of 1-60 minutes. For the example of PTFE, the temperatures must be higher than 130° C. in order to reach the glass transition temperature of PTFE, where it is in the viscous state. In the case of a graphite/PPS/PTFE compound, the temperature should be lower than the melting temperature of PPS, which is 274° C.

In an extrusion stage 3 is used after the kneading stage 2, the compound is extruded as a pliable and malleable material from an extruder. The compound passes through an extrusion nozzle to form an extruded compound rod, for example with rectangular cross section.

The extruded rod is transported on a conveyor belt into a first compression stage 4. Such first compression stage 4 is exemplified as an inclined top-pressing conveyor with decreasing height in the direction of transportation such that the height of the rod is decreased by its way through compression stage 4. This single operation can be used to quickly reduce the height of the rod, while the width is increased to create a quasi-endless band of the compound.

Optionally, a calendering stage 5 is added with calendering stations with decreasing gap height in subsequent calendering stations to form a relatively thin sheet with a requested final thickness. Advantageously, the thickness of the rod when transformed into a band is decreased to less than 2 mm, optionally to less than 1 mm. The final thickness of the band is optionally less than a mm, and can be made as thin as a few tenths of a mm. During this calendering stage 5, nano-fibril formation is further enhanced, for example in PTFE. However, the PTFE content is typically low, for example lower than 0.5wt. %. For good conductivity, the carbon content is high, typically, above 70 wt. %.

In transport stage 6, the temperature of the compound band is maintained to keep it malleable, for example by adjusting the temperature of the conveyor surface and assuring that there is thermal conduction between the conveyor surface and the band.

In a cutting and cropping stage 7, the sheet is truncated into required dimensions, typically by a knife. Optionally, the scrap is returned to the container in stage 2 in order to be recycled in the fabrication process.

The cropped and cut sheet is inserted into a press-form, which is then subject to heating in a heating station 23 prior to insertion into a press 11 of a hot-compaction stage 8, where hot-compaction is provided. For example, the start of the hot-compaction in the press 11 of stage 8 is done at a first predetermined temperature, typically in the range of 200-400° C., advantageously in the range of 300° C.-350° C. A useful applied pressure is between 100 and 300 MPa, however, depending on the hot-compaction temperature. An advantage of hot compression is a short press-compaction time, which optionally is in the order of 1 second, optionally in the range of 0.5-2 seconds. For example, during the hot-compaction, the density of the pressed material increased at least 1.5 times, for example in the range of 1.5 to 3 times, such as in the range of 2 to 2.5 times.

The press 11 used in the hot-compaction stage 8 is also used to cool down the sheet for the separator plate. In this case, the available time for shaping the separator plate is limited by the speed by which the sheet is cooled down, as the shaping in the hot-compaction stage should be finished before reaching the glass transition temperature of the polymers in the sheet, which as an example is 85° C. for PPS. A quick hot-compaction procedure is beneficial in that the product can be pressed into its desired and final shape before the glass temperature is reached of one or more polymers in the compound. Additionally, quick cooling down of the sheet during hot-compaction has an advantage of speeding up the production process, in general.

For example, after the hot-compaction, separator plates are collected in a container 9.

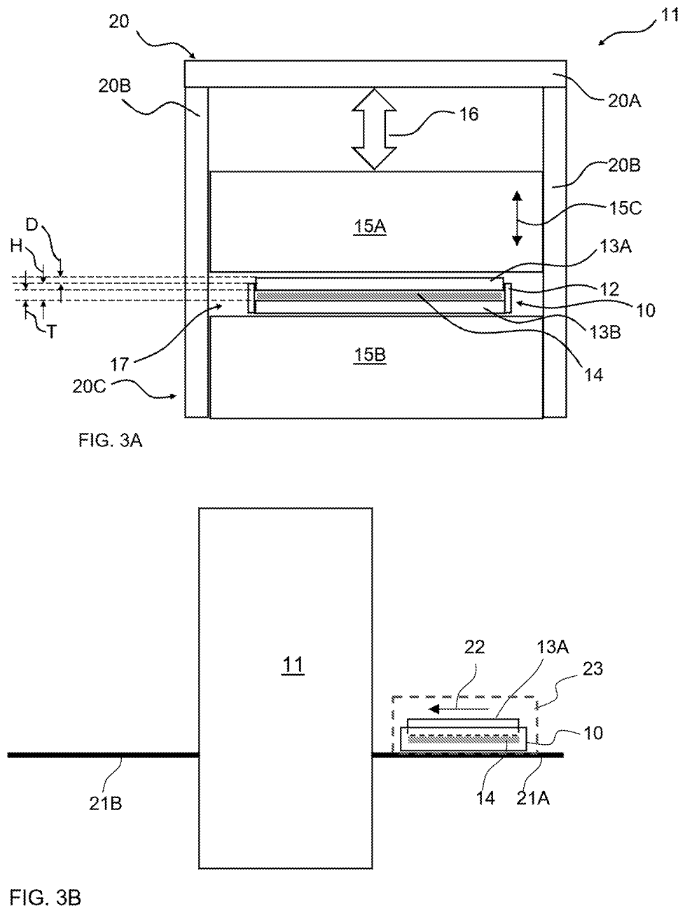

An example of a press-form 10 for the hot-compression in stage 8 is illustrated in a front-view sketch FIG. 3A. The polymer sheet 14, for example an MPP, is inserted into a press-form 10 between to shaping press-plates 13A, 13B supported by a support-frame 12. At least one of the press-plates 13A, 13B, but typically both, has a flow field imprint pattern for transfer to the sheet 14 during the hot compression phase. The press-form 10 is positioned in a press-region 17 between two press-blocks 15A, 15B, which are pressed together by force from an actuator 16 acting on the first and upper press-block 15A. When the first press-block 15A is lowered by force from the actuator 16, it presses onto the upper press-plate 13A, which is arranged vertically movable inside the support-frame 12 so as to transmit the pressure from the upper press-block 15A onto the sheet 14 for compression and embossing the flow field pattern into the sheet 14.

The bottom press-plate 13B in combination the support-frame 12 forms a hollow of height H into which the polymer sheet 14 is inserted. As the polymer sheet 14 has a thickness T<H, a portion of the hollow can be occupied by the cover press-plate 13A. The latter is partially inserted into the support frame 12 and extends a distance D above the upper edge of the support frame 12, and can, thus, be pressed down during hot-compaction.

Optionally, the upper edge of the support-frame 12 is used as a motion-stop for the upper press-block 15B. This implies that the cover press-plate 13A is pressed the distance D into the hollow for the compression of the sheet 14 and formation of the separator plate. Alternatively, the cover press-plate 13A is pressed a distance less than the distance D into the hollow. For example, the pressure exerted by the press in combination with an adjustment of the volume of the sheet inside the hollow determine the distance by which the cover press-plate 13A is pressed down into the hollow. A further option is use of a knuckle-joint press, which exerts strong force until its dead point, at which no further reduction of the distance between the press-blocks 15A, 15B is achieved. In principle, however, an upper press block 15A having a lower side that fits into the hollow is able to press the cover-press-plate even deeper into the hollow than the distance D. Various options exist for such press configurations.

The fast hot compression procedure is shaping the sheet 14 into a separator plate, MPP or BPP, with flow fields for gas and optionally for coolant. As already mentioned, the press-plates 13A, 13B need to be highly rigid and stable in order for the separator plate 14 to attain the correct dimensions and shape. For this reason, the press-plates 13a, 13b have to be made in a hard material.

In order to prevent escape of material from the press-form 10, the press-plates 13a, 13b need to be tightly abutting the inner wall of the support-frame 12. Even further, the contraction of the press-plates during cooling should not differ from the contraction of the sheet 14 during cooling.

In order to realize high-speed hot-compaction while at the same time cooling the formed sheet down within short time, materials for the press-form in the press 11 are provided with high thermal conductivity in order to take out heat and thereby cooling down the pressed MPPs as fast as possible.

Examples of such materials that have are molybdenum, tungsten and some aluminum alloys like 2024-T351, 7075-T651 that have thermal conductivities of, respectively, 143, 197, 121, and 130 W/(m·K). However, in particular, molybdenum has been found advantageous due to its high strength, which is comparable to steel, and its high thermal conductivity. Molybdenum has a high hardness of 225 according to the Brinell method. Additionally, during the cooling, molybdenum has a low degree of thermal contraction.

The press 11 comprises a press frame 20. The press frame 20 has an upper part 20A and side parts 20B and a lower part 20C. The lower part 20C is connected to the lower press-block 15. The side parts 20B connect the lower part 20C with the upper part 20A of the press frame 20. When the actuator 16 is acting on the upper press-block 15B, the force exerted on the upper press-block 15B is transferred to the upper press-plate 13A.

FIG. 3B is a schematic side view of the press 11 and illustrates a heating station 23 that is heating the press-form 10 to a predetermined first temperature, for example to 300° C. or above, suitable for start of the hot-compaction prior to insertion of the press-form 10 into the press 11. Once heated, the press-form 10 is moved by a conveyor 21A, as indicated by arrow 22, into the press 11. Once, inside the press 11, the hot-compaction is performed by the pressure between the two press-blocks 15A, 15B. The metallic press-blocks 15A, 15B are held at a press-block temperature that is much lower than the press-form temperature. For example, the press-blocks 15A, 15B are held at 70° C. by controlled cooling. Due to the temperature difference and the press-blocks 15A, 15B having a much larger volume than the press-plates 13A, 13B, the press-form 10 is cooled efficiently by the press-blocks 15A, 15B from both sides during the hot-compaction. After the hot-compaction, the press-form 10 is moved out of the press 11 again on conveyor 21A or 21B. At this stage, the sheet 14 has already hardened into a rigid separator plate with the embossed flow field pattern. This illustrated procedure is fast and smooth and useful for an efficient production line.

If the separator plates are produced as MPP, the MPPs can be used for pair-wise assembly into BPPs, if BPPs are desired as final product. A typical assembly method includes gluing around the perimeters of two MPPs in back-to-back abutment. The requirements for the glue utilized for PEM BPPs are very similar to the polymers used in the MPP compound, i.e. mechanical, thermal and chemical stability within the working temperature range of high-temperature PEM fuel cell. It should be mentioned that forming BPPs by the process described here allows also to get gas flow channels and portholes during the procedure, so that no additional operations, like milling, are needed.

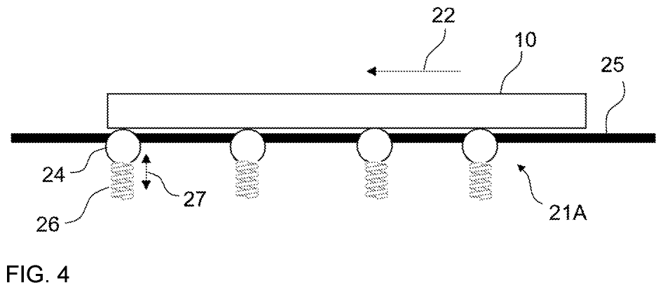

FIG. 4 illustrates an optional conveyor 21A, which in this embodiment is exemplified a ball transfer table 25. The balls 24 are supported for rolling in bearings so that the press-form 10 can easily slide over the table 25 in and out of the press. With reference FIG. 3A and 3B, once, the press-form 10 is inside the press 11 and subject to pressure by the upper pressure block 15A, the press-form 10 presses the balls 24, which are springloaded 26, 27, as illustrated in FIG. 4, into the table 25, so that the press-form 10 rests on the upper side of the table. The lower side of the table 25 is supported by the lower press block 15B.

1. A method of producing separator plates, the method comprising
providing a press-form comprising a bottom press-plate (and a support frame and a hollow formed by the bottom press-plate and the support frame, the hollow having a height H, the press-form also comprising a cover press-plate covering the hollow; wherein at least one of the bottom press-plate and the cover press-plate comprises a template for embossing a fluid flow pattern in a separator plate formed in the press-form;
providing an endless band of a malleable compound, the compound comprising a mix of thermoplastic polymer material and a powder of electro-conductive filler,
cutting and cropping a sheet from the band, the sheet having a constant thickness T of less than H for fitting into the hollow, placing the cut and cropped sheet into the hollow, and placing the cover press-plate above the sheet for covering the sheet in the hollow,
providing a press with a press-region for accommodating the press-form for hot compaction of the sheet inside the press-form in the press-region,
in a hot press-moulding stage, hot-compacting the sheet in the press-form into a separator plate by pressing the press-plates towards each other and shaping the flow pattern in the sheet with the template,
reducing the temperature of the sheet to under the glass transition temperature for the thermoplastic polymer material while under pressure in the press-form to cause rigid solidification, and then removing the sheet as a rigidly solidified separator plate from the press-form,
wherein the press is provided with two oppositely positioned metallic press blocks and a driving mechanism for pressing the two press-blocks towards each other, and wherein a conveyor is connected to the press-region for moving the press-form in and out of the press-region;
wherein the method comprises,
after placement of the sheet in the press-form, while the sheet is inside the press-form, heating the press-form and the sheet in a heating station outside the press-region to a first predetermined temperature, which is above the glass transition temperature for the thermoplastic polymer material but below the melting temperature for the thermoplastic polymer material in order to compact the compound in malleable but not molten state;
only after heating of the press-form moving the press-form by the conveyor into the press-region in between the press blocks, then exerting pressure on the press-form by the press blocks and simultaneously lowering the temperature of the press-form from the first predetermined temperature to a second predetermined temperature below the glass transition temperature during the hot-compaction by transferring thermal energy from the press-form to both of the press-blocks,
then removing the press-form from the press-region by the conveyor.

2. The method according to claim 1, wherein the method in a repeated process comprises providing a further press-form, and during the hot-compaction of the sheet in the press-form, filling the further press form with a corresponding further cropped sheet, and after removal of the press-form from the press-region by the conveyer, inserting the further press-form into the press-region by the conveyer for hot compaction of the further sheet into a further separator plate.

3. The method according to claim 1, wherein the cover press-plate is fitting tightly into the hollow and wherein the method comprises positioning the cover press-plate inside the hollow and resting the cover press-plate on the sheet with a portion of the cover press-plate extending a distance D above the support-frame and hot-compacting the sheet in the press-form into a separator plate by pressing the press-blocks towards each other and pushing the cover press-plate a distance of no more than D deeper into the hollow by the press-blocks.

4. The method according to claim 1, wherein the method comprises providing the press-blocks with a thickness of no less than ten times the thickness of the press-plates in order for the press-blocks to have volume enough to take up the heat from the press-plates during the simultaneous cooling and hot-compaction.

5. The method according to claim 1, wherein the method comprises providing a cooling system for the press-blocks and maintaining the press-blocks at a second predetermined temperature by cooling, where the second temperature is below the glass transition temperature of the thermoplastic polymer.

6. The method according to claim 1, wherein the method comprises maintaining the press-blocks at a second predetermined temperature in the range of 50-100° C., for example on the range of 60-80° C.

7. The method according to claim 1, wherein the conveyor comprises a ball transfer table in which rotational balls are embedded for sliding of the press-form on the rotational balls over the table into the press, wherein the balls inside the press-region are spring-loaded for being pressed into the table during pressing of the press-form between the press blocks.

8. The method according to claim 1, wherein the method comprises providing the bottom plate and the cover plate in molybdenum.
